(19) United States
(12) Patent Application Publication
(10) Pub. No.: US 2020/0303979 A1
(43) Pub. Date: Sep. 24, 2020

(54) ROTOR AND ELECTRICAL MACHINE

(71) Applicant: FEAAM GmbH, Neubiberg (DE)

(72) Inventor: Gurakuq DAJAKU, Neubiberg (DE)

(21) Appl. No.: 16/821,867

(22) Filed: Mar. 17, 2020

(30) Foreign Application Priority Data
Mar. 22, 2019 (DE) 10 2019 107 452.5

(51) Int. Cl. H02K 1/27

(52) U.S. Cl. CPC H02K 1/2773

(57) ABSTRACT

A rotor (1) is provided for an electrical machine, having at least one magnetic pole comprising a main magnet (2) and at least one auxiliary magnet (4), with the magnetic axis of the main magnet (2) being different from the magnetic axis of the auxiliary magnet (4). Furthermore, an electrical machine comprising the rotor (1) is described.

The present invention relates to a rotor for an electrical machine as well as to an electrical machine comprising the rotor and a stator.

Electrical machines excited by permanent magnets are enjoying increasing popularity due to their high power density and high efficiency. Depending on the rotor type, a distinction is made between machines with buried permanent magnets in the rotor and machines with surface permanent magnets in the rotor. In both cases, these are typically synchronous machines.

In the case of buried magnets, these may be inserted into the rotor in different ways, for example as a tangential magnet, in a V-shape or as a spoke magnet, i.e. radially aligned.

Especially in applications of permanent magnet excitation synchronous machines (PMSM) in vehicles, there is a desire to further increase the magnet volume per magnetic pole in order to increase the torque density of the permanent magnet excitation machine.

This task is solved with respect to the rotor and the electrical machine with the objects of the independent claims.

Further developments and advantageous designs are specified in the dependent claims.

In one embodiment, a rotor for an electrical machine has at least one magnetic pole. The pole is formed by a main magnet and at least one auxiliary magnet, the magnetic axis of the main magnet being different from the magnetic axis of the auxiliary magnet.

In other words, the main magnet and the at least one auxiliary magnet are magnetized in different directions. By way of example, the main magnet is formed as a surface magnet and magnetized in the radial direction, while the at least one auxiliary magnet is aligned in the radial direction and thus magnetized in the tangential direction.

Preferably, the at least one auxiliary magnet serves to amplify the magnetic flux of the main magnet. As a result, the resulting magnetic flux of this rotor pole is increased so that a higher torque can be generated with the proposed rotor than with a conventional rotor.

In one embodiment, the geometry of the main magnet differs from that of the auxiliary magnet. The geometry includes, for example, the length of the magnets, the thickness of the magnets, their outer shape, etc.

In one embodiment, the main magnet and the at least one auxiliary magnet contribute to the magnetization of the at least one magnetic pole. The auxiliary magnet is preferably aligned with its direction of magnetization in such a way that the magnetic flux of the main magnet is amplified.

The main magnet and the auxiliary magnet are preferably permanent magnets in each case.

By way of example, the main magnet may be designed as a surface magnet. The auxiliary magnet or the auxiliary magnets can be designed as buried spoke magnets.

In another embodiment, the main magnet is designed as a V-shaped magnet. The at least one auxiliary magnet is designed as a buried spoke magnet.

If two auxiliary magnets are associated to the main magnet, they can be arranged on opposite sides of the main magnet, for instance. This arrangement is preferably axis-symmetric.

The mechanical angle between the axis of the auxiliary magnet and the radial rotor axis is 0 degrees in one embodiment.

In another embodiment, the mechanical angle between the auxiliary magnet axis (or axes) and the radial rotor axis is different from 0 degrees.

The auxiliary magnet(s) can be located closer to the rotor surface, i.e. to the air gap, or closer to the rotor axis.

In an embodiment in which the main magnet is flanked by an auxiliary magnet on each side, a geometrical arrangement is obtained, which is based on the Greek letter Pi (Π). In line with this, the resulting rotor is called a Π-rotor.

In one embodiment, the rotor comprises both spoke-shaped main magnets and surface main magnets. It may be the case that auxiliary magnets are either associated to the surface magnet or to the spoke magnets or to both of them.

For example, a six-pole rotor may be formed with two opposite spoke magnets and two surface or V-shaped magnets offset by 90° relative thereto.

Further details and advantageous designs of the proposed principle are explained in more detail below on the basis of drawings.

### IN THE FIGURES

FIG. 1 shows an exemplary embodiment of the proposed principle on the basis of a six-pole rotor,

FIG. 2 shows a further exemplary embodiment of a six-pole rotor according to the proposed principle,

FIG. 3A shows a further exemplary embodiment of a six-pole rotor according to the proposed principle,

FIG. 3B shows a further exemplary embodiment of a six-pole rotor according to the proposed principle,

FIG. 4A shows a further exemplary embodiment of a six-pole rotor according to the proposed principle,

FIG. 4B shows a further exemplary embodiment of a six-pole rotor according to the proposed principle,

FIG. 5A shows a further exemplary embodiment of a six-pole rotor according to the proposed principle,

FIG. 5B shows a further exemplary embodiment of a six-pole rotor according to the proposed principle,

FIG. 6 shows a further exemplary embodiment of a six-pole rotor according to the proposed principle,

FIG. 7 shows a further exemplary embodiment of a rotor according to the proposed principle,

FIG. 8 shows further exemplary embodiment of a rotor according to the proposed principle,

FIG. 9 shows a further exemplary embodiment of a rotor according to the proposed principle,

FIG. 10 shows a further exemplary embodiment of a rotor according to the proposed principle,

FIG. 11 shows a further exemplary embodiment of a rotor according to the proposed principle, and

FIG. 12 shows an exemplary embodiment of an electrical machine comprising a rotor according to the proposed principle.

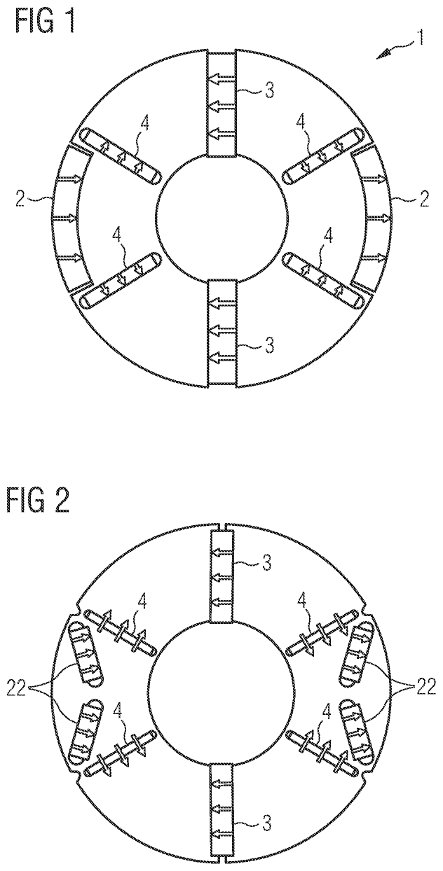

FIG. 1 shows an exemplary embodiment of a rotor 1 according to the proposed principle. The rotor 1 comprises two main magnets 2 which are formed as surface magnets. The main magnets 2 have the same direction of magnetization. Furthermore, two spoke magnets 3 are provided. The spoke magnets 3 also have the same direction of magnetization and are arranged so as to be 180° offset to each other. The two surface magnets 2 are offset by 90° thereto. This results in a rotor with six poles.

Each of the surface magnets 2 has two auxiliary magnets 4 laterally associated to it, which are designed as spoke magnets. Each surface magnet 2 and the two auxiliary magnets 4 associated to it form one magnetic pole each.

The auxiliary magnets serve to amplify the magnetic flux of the main magnet associated to them.

The auxiliary magnets 4 associated to a main magnet 2 are each magnetized in the opposite tangential direction with respect to each other.

In the present example, the auxiliary magnets 4 and the spoke magnets 3 are distributed along the circumference at a distance of approx. 60 degrees.

The thickness of the auxiliary magnets 4 and of the spoke magnet 3 is different in this design.

Compared to a conventional design of a six-pole rotor without the auxiliary magnets 4, with the proposed exemplary embodiment the resulting magnetic flux of the rotor poles including the main magnets 2 is increased and thus the proposed PM rotor is able to generate a higher torque than without the auxiliary magnets 4.

FIG. 2 shows another exemplary embodiment of a rotor according to the proposed principle, which is largely similar to that of FIG. 1 in terms of design and advantageous functionality. This geometrical and functional correspondence of the exemplary embodiments is always valid in the following, unless otherwise described.

Instead of the surface magnets 2 of FIG. 1, however, V-shaped main magnets 22 are provided in the example of FIG. 2, which in turn have the radially aligned auxiliary magnets 4 associated to them in pairs.

Compared to the surface magnets 2, the buried V-shaped magnets 22 have the advantage that no additional measures are required to keep the magnets in place at high speeds, such as with shielding cylinders, bandages or the like. Instead, mechanical stability is ensured by the iron bridges of the rotor on the side of the magnets on the air gap side.

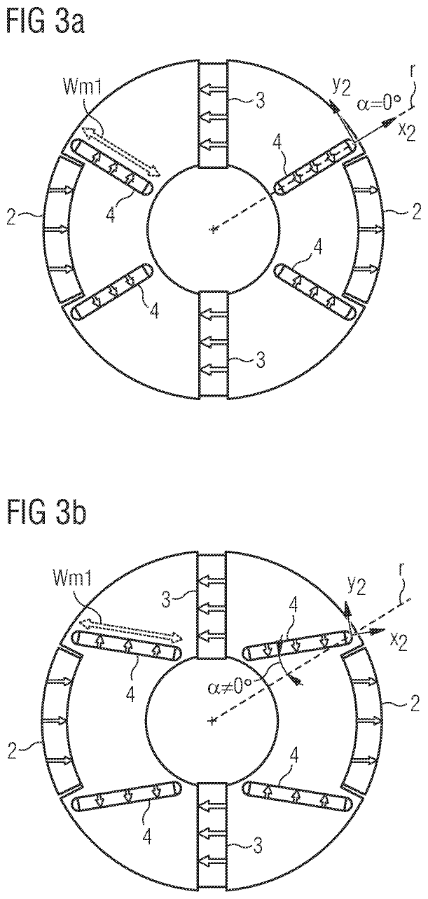

The design of FIG. 3A is similar to that of FIG. 1. It should be underlined here that the auxiliary magnets 4 have an angle α of 0° with respect to the radial axis r. Thus, in the example of FIG. 3A, the auxiliary magnets 4 are aligned exactly in the radial direction of the rotor relative to the axis of rotation.

In contrast, FIG. 3B shows an alternative embodiment. In this case, the ends of the auxiliary magnets 4 facing the rotor axis are turned out of the exact radial axis so that the auxiliary magnets 4, which are associated to each other within one pole, are aligned so as to be almost parallel to each other. This results in an angle α of the main axis of the auxiliary magnets 4 in relation to the radial axis, which is different from 0.

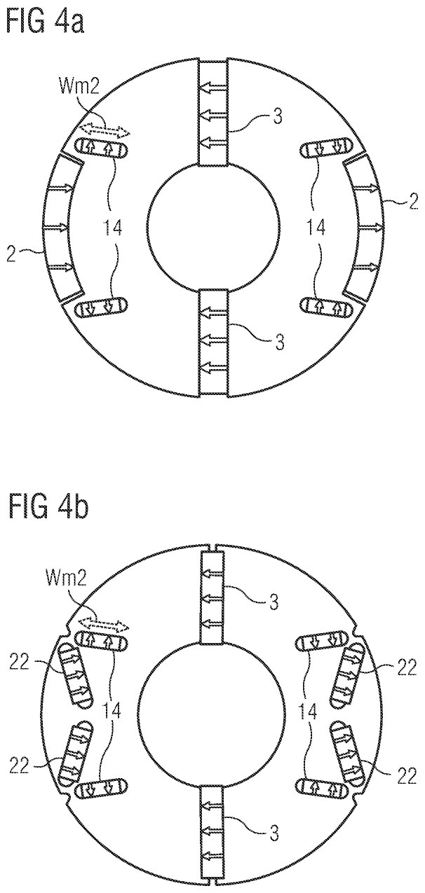

FIG. 4A shows another exemplary embodiment according to the proposed principle, based on FIG. 3B. The exemplary embodiment of FIG. 4A differs from that of FIG. 3B only in that the extension of the auxiliary magnets 4 is shortened. In FIG. 3B, the extension of the auxiliary magnets is almost from the outer radius of the rotor, adjacent to the air gap, to the inner radius of the rotor adjacent to the axis. In the main direction, auxiliary magnets thus are formed to have a length Wm1.

Compared to this, in FIG. 4A a shortened auxiliary magnet 14 is provided in each case, which, for example, has only half the length Wm2 of FIG. 3B, but is oriented to be adjacent to the outer radius and extends into the boundary area of the rotor towards the air gap. These auxiliary magnets are marked with reference sign 14 and further have a non-zero angle α as defined in FIG. 3B.

FIG. 4B shows the exemplary embodiment of FIG. 4A, but the surface magnets 2 are replaced by V-shaped magnets 22 as described in FIG. 2.

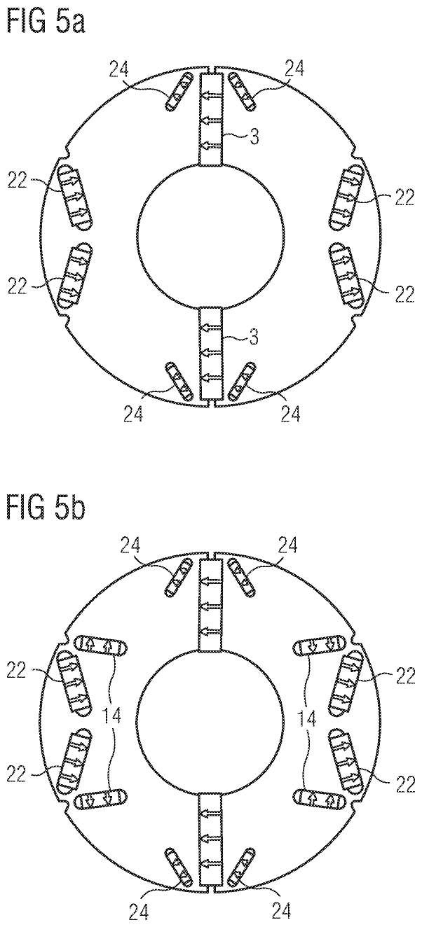

FIG. 5A shows an alternative embodiment based on the design of FIG. 4B. The main magnets of FIG. 5A are, as in FIG. 4B, two oppositely arranged spoke magnets 3 and two opposite V-shaped main magnets 22, offset by 90° with respect to the spoke magnets 3. The auxiliary magnets, however, are not associated to the V-shaped magnets 22 but to the spoke magnets 3.

Here, two auxiliary magnets 24 are laterally associated to each spoke magnet 3 in tangential direction, which are turned out of the radial direction. They can, for example, each have an angle of 30 degrees to spoke magnet 3.

With regard to the spoke magnet 3, the auxiliary magnets 24 are formed to be axially symmetric and have a shortened length in analogy to the auxiliary magnet 14 in FIGS. 4A and 4B. They are arranged in the bordering area towards the air gap and are designed so as to have essentially the same direction of magnetization with respect to one another and so as to comprise the associated spoke magnets 3.

FIG. 5B shows an exemplary embodiment comprising a combination of all features of FIGS. 4B and 5A. Thus, auxiliary magnets 24 are associated to the spoke magnets 3 and additional auxiliary magnets 14 are associated to the V-shaped main magnets 22.

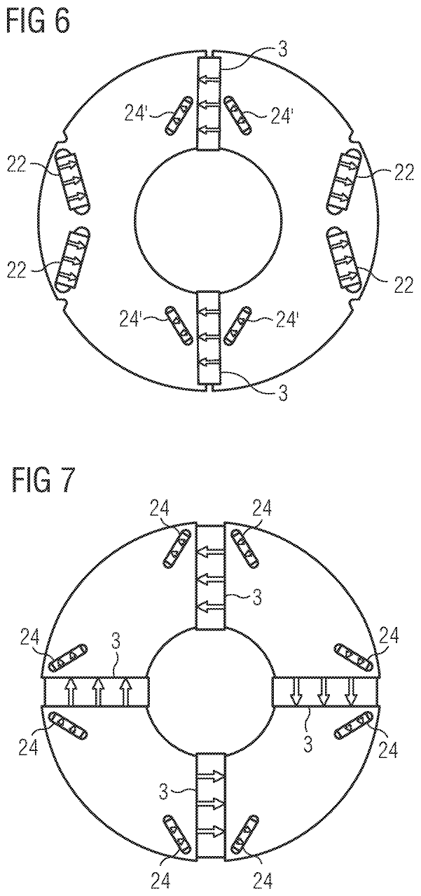

FIG. 6 shows a modification of the design of FIG. 5A. Here, the auxiliary magnets 24′ are not located in the outer edge of the rotor, which is associated to the air gap, but they are shifted towards the axis and realized in the bordering area of the inner radius, i.e. facing the axis. The angles between the auxiliary magnets 24′ and the spoke magnets 3 do not change.

FIG. 7 shows another exemplary embodiment of a rotor according to the proposed principle. In contrast to the previous Figures, only one type of main magnets is provided, namely spoke magnets 3 which are distributed at 90° intervals along the circumference and aligned in the radial direction. Each of the spoke magnets 3 has two auxiliary magnets 24 associated to it, which are aligned and arranged as described in FIG. 5B.

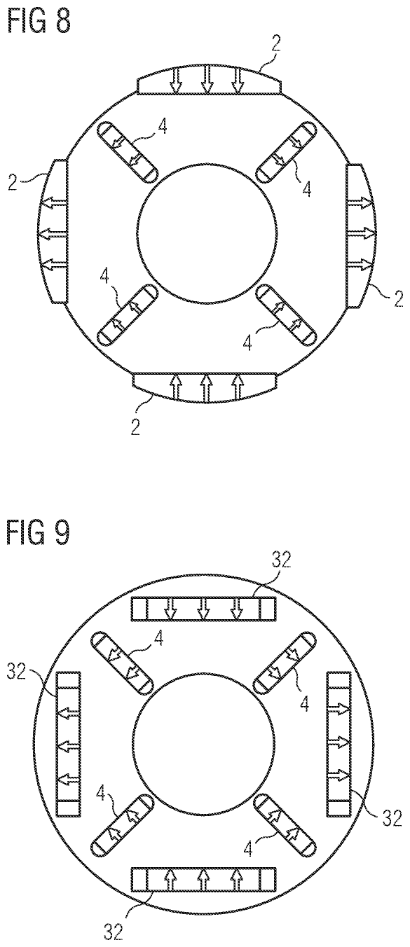

FIG. 8 shows a rotor with four surface magnets 2, which are arranged along the circumference so as to be shifted by 90° to each other. Shifted by 45° relative thereto along the circumference, a total of four auxiliary magnets 4 are provided, which are also shifted by 90° to each other and distributed along the circumference. The auxiliary magnets 4 are therefore each arranged exactly in the middle between two adjacent magnetic poles, extend in radial direction and reach from the area of the inner edge of the rotor to the area of the outer edge, i.e. from the area at the axis to the area at the air gap. The directions of magnetization are shown in the Figure.

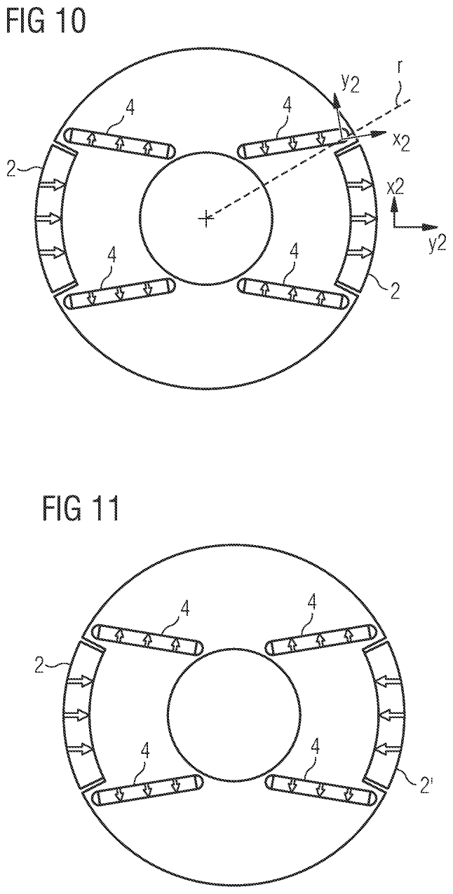

FIG. 9 shows still another exemplary embodiment in which the surface magnets 2 are replaced by so-called inset magnets 32, i.e. buried magnets which are essentially bar-shaped and aligned with the main direction in tangential direction just like the surface magnets 2. The rest of the design corresponds to that of FIG. 8 in terms of structure and mode of operation. Again, four main magnets 32 and four auxiliary magnets 4 are provided here.

FIG. 10 shows another exemplary embodiment according to the proposed principle. Based on the example according to FIG. 3B, the spoke magnets 3 are omitted. Since the main magnets 2 have the same direction of magnetization as in FIG. 3B, the result is a rotor with only two magnetic poles.

FIG. 11 shows a modification of the design of FIG. 10. Compared to FIG. 10, the main magnets 2 in FIG. 11 are magnetized in the opposite direction. This results in a four-pole PM rotor in which, as in FIG. 10, the main magnets 2 are supplemented with auxiliary magnets in Π-shape.

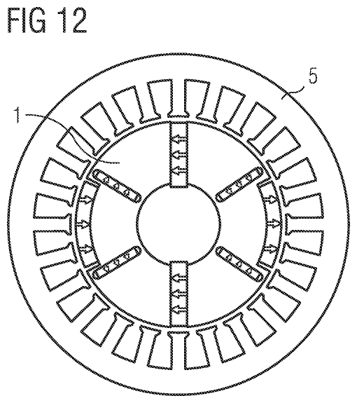

FIG. 12 shows the rotor 1 of FIG. 1 together with an exemplary stator 5. An electrical machine comprises the stator 5 and the rotor 1 according to the proposed principle. The stator 5 may be provided with tooth-concentrated windings or distributed windings.

1. A rotor (1) for an electrical machine, comprising
at least one magnetic pole comprising a main magnet (2) and at least one auxiliary magnet (4),
wherein the magnetic axis of the main magnet (2) is different from the magnetic axis of the auxiliary magnet (4).

2. The rotor according to claim 1,
wherein the geometry of the main magnet (2) differs from that of the auxiliary magnet (4).

3. The rotor according to claim 1 or 2,
in which the main magnet (2) and the auxiliary magnet (4) contribute to the magnetization of the at least one magnetic pole.

4. The rotor according to claim 1 or 2,
wherein the auxiliary magnet (4) is oriented with its direction of magnetization such that the magnetic flux of the main magnet (2) is amplified.

5. The rotor according to claim 1 or 2,
wherein the main magnet (2) and the auxiliary magnet (4) are each permanent magnets.

6. The rotor according to claim 1 or 2,
in which at least one further magnetic pole is provided which comprises a main magnet (2) and at least one auxiliary magnet (4),
wherein the magnetic axis of the main magnet is different from the magnetic axis of the auxiliary magnet.

7. The rotor according to claim 1 or 2,
in which the main magnet (2) is formed as a surface magnet and the auxiliary magnet (4) is formed as a buried spoke magnet.

8. The rotor according to claim 1 or 2,
in which the main magnet is formed as a V-shaped magnet (22) and the auxiliary magnet (4) is formed as a buried spoke magnet.

9. The rotor according to claim 1,
wherein a main magnet of a different type (3) is provided which has a different direction of magnetization than the main magnet (2).

10. The rotor according to claim 9,
wherein at least one auxiliary magnet (24) is also associated to the main magnet of the different type (3).

11. The rotor according to claim 9 or 10,
wherein the thickness of the auxiliary magnet (4) differs from the thickness of the main magnet of the different type (3) designed as a spoke magnet.

12. The rotor according to claim 1 or 2,
wherein a further auxiliary magnet is associated to the main magnet (2), the magnetic pole additionally comprising the further auxiliary magnet, and the main magnet and the two auxiliary magnets (14) being arranged in a Π-shape.

13. An electrical machine comprising a rotor according to claim 1 or 2 as well as a stator, wherein the rotor is mounted so as to be rotatable with respect to the stator.
